(19) United States
(12) Patent Application Publication
(10) Pub. No.: US 2025/0381838 A1
(43) Pub. Date: Dec. 18, 2025

(54) FUEL TANK VALVE ASSEMBLY

(71) Applicant: Eaton Intelligent Power Limited, Dublin 4 (IE)

(72) Inventors: Raymond Bruce MCLAUCHLAN, Macomb Township, MI (US); Joseph S. TENBROEK, Ann Arbor, MI (US); Brian James O'NEIL, Chesterfield Twp, MI (US); Mark William HILDEBRANDT, Hartland, MI (US); Robert John BOYCHUK, Rochester Hills, MI (US)

(21) Appl. No.: 19/316,548

(22) Filed: Sep. 2, 2025

Related U.S. Application Data
(63) Continuation of application No. PCT/IB2024/054196, filed on Apr. 30, 2024.
(60) Provisional application No. 63/499,429, filed on May 1, 2023.

(51) Int. Cl. B60K 15/035; B60K 15/03

(52) U.S. Cl. CPC B60K 15/035; B60K 2015/03296

(57) ABSTRACT

In one embodiment, a valve assembly may include a housing, a cage inside the housing, a first spring arranged inside the housing and outside of the cage, and a poppet inside the cage. The cage may have a first orifice as defined by a bottom edge of the cage, which sits on a first supporting structure of the housing. The first spring may have a top end pressing against a top edge of the cage and a bottom end sitting on a second supporting structure. The poppet may have a top end coupled to an armature movable longitudinally, and a bottom end coupled to a hat-shaped valve. The hat-shaped valve may be coupled to a second spring under the hat-shaped valve, which is configured to push the hat-shaped valve upwards and cause the hat-shaped valve to be releasably engaged with a seal structure of the poppet.

### PRIORITY

This application claims the benefit under 35 U.S.C. § 365(c) of International Patent Application No. PCT/IB2024/054196, filed 30 Apr. 2024, which claims the benefit under 35 U.S.C. § 119(e) of U.S. Provisional Patent Application No. 63/499,429, filed 1 May 2023, which is incorporated by reference herein in its entirety.

### TECHNICAL FIELD

This disclosure relates generally to a fuel tank system, and more particularly to a valve assembly to control vapor in the tank.

### BACKGROUND

A fuel tank of a hybrid vehicle may be a close environment as controlled by a fuel tank valve. Fuel tank valves can control the vent vapors from a fuel tank to a canister that stores the vapors and is periodically purged.

### SUMMARY

In one embodiment, a valve assembly for a fuel tank is disclosed, in particular, a valve assembly comprising: a housing; a cage arranged inside the housing, wherein the cage has a first orifice as defined by a bottom edge sitting on a first supporting structure located at a first position of an inner sidewall of the housing; a first spring arranged inside the housing and outside of the cage, wherein the first spring has a top end pressing against a top edge of the cage and a bottom end sitting on a second supporting structure located at a second position of the inner sidewall of the housing; and a poppet arranged inside the cage, wherein the poppet has a top end coupled to an armature movable longitudinally, and a bottom end coupled to a hat-shaped valve, wherein: the hat-shaped valve is arranged inside the housing and coupled to a second spring under the hat-shaped valve; and the second spring is configured to push the hat-shaped valve upwards and cause the hat-shaped valve to be releasably engaged with a seal structure of the poppet.

In one embodiment, a valve assembly for a fuel tank is disclosed, in particular, a valve assembly for a fuel tank, comprising: a housing; a cage arranged inside the housing, wherein the cage has a first orifice as defined by a bottom edge sitting on a first supporting structure located at a first position of an inner sidewall of the housing; a first spring arranged inside the housing and outside of the cage, wherein the first spring has a top end pressing against a top edge of the cage and a bottom end sitting on a second supporting structure located at a second position of the inner sidewall of the housing; and a poppet arranged inside the cage, wherein the poppet has a top end coupled to an armature movable longitudinally, and a bottom end coupled to a hat-shaped valve, wherein the hat-shaped valve has an outside surface customized to guide vapor flow when the vapor flow passes through the valve assembly.

In a particular embodiment, which may combine the features of some or all above embodiments, the housing may be connected to an inlet and an outlet, and wherein the inlet may be connected to the fuel tank and the outlet is connected to a canister configured to store fuel vapor released from the fuel tank through the inlet and the valve assembly.

In a particular embodiment, which may combine the features of some or all above embodiments, the hat-shaped valve may have a sloped or curved outside surface configured to guide a vapor flow to reduce friction when the vapor flow is released from the fuel tank, passing through the inlet and the valve assembly to reach to the outlet.

In a particular embodiment, which may combine the features of some or all above embodiments, the first orifice may correspond to a bottom aperture as defined by the bottom edge of the cage, and, in a closed state, the first orifice may be sealed by the seal structure of the poppet through a top portion of a cage seal coupled to the bottom edge of the cage.

In a particular embodiment, which may combine the features of some or all above embodiments, the inner sidewall of the housing at the first position may define a second orifice, and the second orifice may be sealed by the bottom edge of the cage in a closed state through a cage seal.

In a particular embodiment, which may combine the features of some or all above embodiments, the cage may have one or more openings on a cage sidewall configured to allow vapor flow to pass through.

In a particular embodiment, which may combine the features of some or all above embodiments, the poppet may have an inner opening in the seal structure of the poppet, and the inner opening of the poppet may be scaled by an inner seal on the top of the hat-shaped valve as pressed by the second spring under the hat-shaped valve.

In a particular embodiment, which may combine the features of some or all above embodiments, when the valve assembly switches from the closed state to a first open state of a two-stage opening process, the poppet may be configured to move upwards with the armature, and the first orifice corresponding to the bottom aperture of the cage may be opened in the first open state.

In a particular embodiment, which may combine the features of some or all above embodiments, in the first open state of the two-stage opening process, the fuel tank may have an inner pressure being higher than a threshold pressure, and the second orifice may remain being sealed by the bottom edge of the cage as pressed downwards by the inner pressure of the fuel tank.

In a particular embodiment, which may combine the features of some or all above embodiments, when the valve assembly switches from a first open stage to a second open state of the two-stage opening process, the inner pressure of the fuel tank may be lower than the threshold pressure, the first spring may be configured to push the cage upwards overcoming the inner pressure of the fuel tank, and wherein the second orifice is opened in the second open state.

In a particular embodiment, which may combine the features of some or all above embodiments, in the second open state, the cage, the poppet, and the hat-shaped valve may be at higher positions, and wherein the first orifice is closed.

In a particular embodiment, which may combine the features of some or all above embodiments, when the fuel tank has an inner pressure higher than a high-threshold pressure that is greater than a spring force of the second spring, the hat-shaped valve may be configured to move downwards to temporarily open an inner opening of the seal structure of the poppet to release the inner pressure of the fuel tank.

In a particular embodiment, which may combine the features of some or all above embodiments, when the inner pressure of the fuel tank falls under the high-threshold pressure, the hat-shaped valve may be configured to move upwards to reseal the inner opening of the seal structure of the poppet.

In a particular embodiment, which may combine the features of some or all above embodiments, the hat-shaped valve may be hollow inside and has an inner surface shape customized to receive a protrude of the poppet extending beyond a bottom surface of the seal structure of the poppet, and the hat-shaped valve may have a smaller size than the first orifice corresponding to the bottom aperture of the cage.

In a particular embodiment, which may combine the features of some or all above embodiments, the hat-shaped valve may be mechanically coupled to an inner seal which is releasably pressed against a bottom surface of the seal structure of the poppet, and the bottom edge of the cage may be mechanically coupled to a cage seal.

In a particular embodiment, which may combine the features of some or all above embodiments, the seal structure of the poppet may be mechanically coupled to an inner seal which is releasably pressed against a top surface of the hat-shaped valve, and the bottom edge of the cage may be mechanically coupled to a cage seal.

In a particular embodiment, which may combine the features of some or all above embodiments, the inner sidewall of the housing may have a chamfer step under the first supporting structure for the cage, and the chamfer step may be configured to smooth vapor flow passing through the valve assembly.

In a particular embodiment, which may combine the features of some or all above embodiments, the valve assembly may be configured to release an inner pressure of the fuel tank using a two-stage opening process to limit a peak flow of fuel vapor.

In a particular embodiment, which may combine the features of some or all above embodiments, the valve assembly may be configured to release an inner pressure of the fuel tank using a mechanical valve when the inner pressure is higher than a threshold pressure.

### BRIEF DESCRIPTION OF THE DRAWINGS

Embodiments in accordance with this disclosure will now be described by reference to the accompanying drawings.

FIG. 1A illustrates a valve system used in a 180-degree valve assembly housing according to certain embodiments of this disclosure.

FIGS. 1B and 1C illustrate components of a two-stage opening structure for the over vacuum release (OVR) functionality.

FIGS. 2A-2C illustrate a two-stage opening process for the OVR functionality.

FIG. 3A illustrates a valve system used in a 180-degree valve assembly housing according to another embodiment of this disclosure.

FIG. 3B illustrates the assembled view and the explored view for assembly components including the poppet.

FIG. 4 illustrates a chamfer step on the inner sidewall of the housing.

### DETAILED DESCRIPTION

Reference will now be made in detail to the examples which are illustrated in the accompanying drawings. Wherever possible, the same reference numbers will be used throughout the drawings to refer to the same or like parts. Those having ordinary skill in the art will recognize that all directional references (e.g., above, below, upward, up, downward, down, top, bottom, left, right, vertical, horizontal, etc.) are used descriptively for the Figures to aid the reader's understanding, and do not represent limitations (for example, to the position, orientation, or use, etc.) on the scope of the disclosure, as defined by the claims.

Particular embodiments of the inventive subject matter now will be described with reference to the accompanying drawings. This inventive subject matter may, however, be embodied in many different forms and should not be construed as limited to the embodiments set forth herein; rather, these embodiments are provided so that this disclosure will be thorough and complete, and will fully convey the scope of the inventive subject matter to those skilled in the art.

In hybrid vehicles, the fuel tank may be a close environment as controlled by a fuel tank valve. Fuel Tank Isolation Valve (FTIV) may be used to selectively isolate the fuel tank from the engine and to control the vent vapors from a fuel tank to a canister that stores the vapors and is periodically purged. The FTIV may manages the fuel tank pressure and release fuel vapor to the canister upon control commands by a controller of the vehicle. Depending on the vehicle's design, the vehicle's controller could selectively activate FTIV to release pressure. For example, when the hybrid vehicle is operating in electric-driving mode, the fuel tank may be isolated from the engine, which means the pressure in the fuel tank may build up. To release such pressure, some vehicles may periodically open FTIV. As another example, during refueling, the user would typically press a button to open up the refueling orifice to so that the air in the fuel tank can come out before the refueling process to release the fuel tank pressure and the during the fuel process to maintain an appropriate fuel tank pressure. When the button is pressed, FTIV may be triggered to open the refueling orifice to release the fuel tank pressure in preparation for refueling process.

In particular embodiments, FVIT may have at least two functionalities: Over Vacuum Release function (OVR) and Over Pressure Release function (OPR). The OVR function may have a two-stage opening mechanism. The purpose of the two-stage opening process is to achieve more gradual pressure release process. For example, in the first stage, when FTIV is instructed to release pressure, the solenoid may lift the poppet to open a small opening (i.e., the inner orifice as defined by aperture at the bottom end of the cage). When the poppet rises, the spring under the hat shape valve may push the OVR seal upwards so that it follows the poppet. While this is happening, if there is sufficient pressure in the top chamber from the fuel tank, the pressure may push the cage downwards to keep the large orifice (as defined by the house and cage) closed. The conical spring may be compressed during the first stage. In the second stage, when the pressure in the top chamber drops to a certain level, the force on the middle conical spring may push the cage upwards, thereby opening up the flow path completely (the large orifice). In short, in the first stage, a smaller opening may be achieved by lifting the valve using a solenoid as controlled by electrical power and signals, and subsequently opening the entire cage as pushed by the conical spring. As a result, a smaller orifice may be first opened, followed by a larger orifice in such two-stage open process, resulting in a gradual opening. The two-stage opening function may be used to decrease peak flow from the fuel tank at higher pressures during a depressurization process and increase the flow from the fuel tank when the tank pressure is relative lower. For example, the two-stage opening process may be triggered by a vehicle refueling event for a hybrid vehicle where the user pushes a button to depressurize the fuel tank which has been a closed and isolated environment before the refueling event.

In particular embodiments, FVIT may use OPR to release excessive pressure in the fuel tank. For example, when there is excessive pressure in the fuel tank, the spring force of the spring under the hat-shaped valve may be overcome by the fuel tank pressure and the hat-shaped valve may be be pushed downwards by the pressure to mechanically open the valve to release the pressure. As such, the OPR functionality may be achieved by pushing the valve downwards by the excessive fuel tank pressure.

In particular embodiments, the valve system disclosed herein may be used in 90-degree valve assembly housing in which an inlet and an outlet are arranged substantially perpendicular with each other. In particular embodiments, the valve system may be used in 180-degree valve assembly housing where the inlet and outlet are generally parallel to each other (but may be aligned with the same or different center axis). When the inlet and outlet do not share the same center axis (e.g., the valve system is used in the 90-degree housing or 180-degree housing with the inlet and outlet that do not share the same center axis), the fuel vapor traveling from the inlet to the outlet through the valve assembly may need to make one or more turn in the moving direction, which increases the fiction for the vapor flow and make the vapor flow's passing through less smooth.

In particular embodiments, the valve assembly may use a hat-shaped valve or cone-shaped valve having a sloped (or curved) outside surface to guide the vapor flow passing through the valve assembly. When the valve is opened in the first stage of the two-stage opening process or in the high pressure opening for the OPR functionality, the outside surface of the hat-shaped valve may be exposed to the vapor passing through the valve and may guide the vapor flow to make a smoother turn (e.g., a 90-degree turn) using the sloped or curved surface. As a result, the vapor flow may pass the valve assembly more smoothly when making the turn as guided by the outside surface of the hat-shaped valve.

In particular embodiments, by using the two-stage opening process, the system may help lessen depressurization peak flow as well as ensure adequate pressure drop in the fuel tank, resulting in a higher level of safety for the fuel tank systems. In other words, the valve system may limit the peak flow by opening a smaller orifice when the pressure is high and may allow a full flow by opening a larger orifice when the pressure is low. In particular embodiments, by using the hat-shaped valve with a sloped or curved outside surface, the valve assembly may guide the vapor flow in making turns and enable a smoother vapor flow passing through the valve assembly. In particular embodiments, the design of the valve assembly may be more durable, cost effective, and production friendly, and may reduce the complexity in the manufacturing process. In particular embodiments, by using similar component geometry and base design, the valve system may allow common components to be used with minimized changes of the existing system, while still offering systematic improvement on force balancing and flow characteristics of the valve assembly during operation.

In particular embodiments, the valve assembly may be specifically designed for a 90-degree or 180-degree fVIT application, improving the vapor flow in FVIT and reducing the costs of manufacturing. In contrast to the FVIT application where the vapor flow doesn't have to make turns, in the 90/180-degree fVIT applications, vapor flow may enter from the inlet, make one or more turns while passing through the valve, and reach the outlet. During this process, the vapor flow may need to make one or more turns in the moving directions. To improve flow and reduce turbulence, the valve assembly may have a poppet that protrudes downwards with its end being engaged with a hat-shaped (or cone-shaped) valve. The geometry of the outside surface of the hat-shaped valve may help guide the vapor flow in making the turns and may reduce or eliminate turbulence. Furthermore, particular embodiments of the valve assembly may have its OPR portion (including the hat-shaped valve and the spring under it) built in-line with the OVR portion i.e., only a single assembly is needed, rather than having two separate assemblies for OVR and OPR portions. The OPR valve including the hat-shaped valve and the spring under it may extend into the OVR portion above during the two-stage opening process. As a result, particular embodiments of the valve assembly may have reduced manufacturing cost.

In particular embodiments, the valve system may not require a top armature spring (i.e., a spring sitting on top of the armature) thereby reducing additional tolerance requirements and eliminating durability development. It also improves repeatability from build-rebuild-test. The valve system may utilize component geometry and base designs (e.g., same armature, solenoid, spring plate, etc.) such that no substantial modification to the entire valve assembly is needed. It may allow for interchangeability to the OVR/OPR settings with adjustable ranges. Moreover, the valve assembly according to this disclosure may prevent depressurization peak flow while still retaining all other performance characteristics.

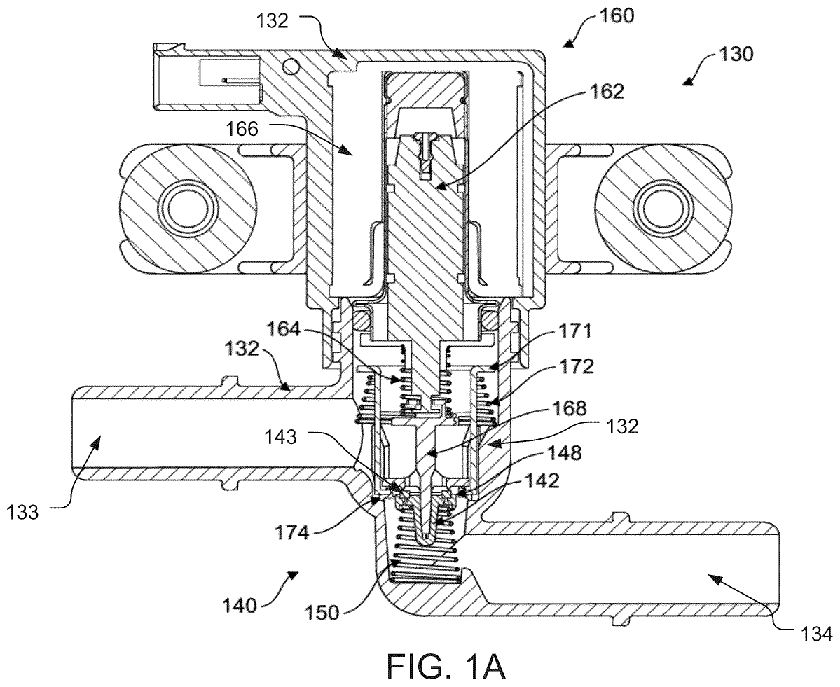

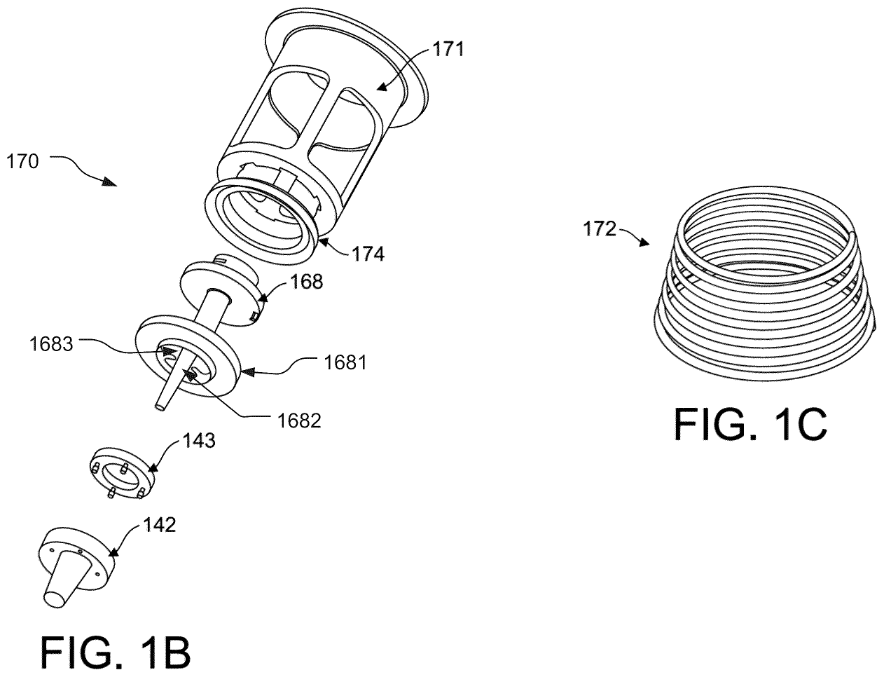

FIG. 1A illustrates a valve system 130 used in a 180-degree valve assembly housing 132 according to certain embodiments of this disclosure. In certain applications, the valve assembly 130 may be utilized with a tank (not shown), such as a fuel tank of a hybrid vehicle. However, it is to be appreciated that of the valve assembly 130 may be used in liquid tanks that store other liquid fluids other than vehicle fuel. In particular embodiments, a valve assembly 130 may include structures for an over pressure relief (OPR) functionality and an over vacuum release (OVR) functionality in an in-line relationship, as described later in details.

Referring to FIG. 1A, wherein like numerals indicate like or corresponding parts throughout the several views, the valve assembly 130 may include a solenoid assembly 160 arranged inside a housing 132. The solenoid assembly 160 may be adapted to receive and be energized by electrical power and to be triggered and controlled by an electrical control signal. The solenoid assembly 160 may include an armature 162, a solenoid spring 164 and a coil 166. The solenoid spring 164 may be configured to generate a force to push the armature 162 upwards. In particular embodiments, the force of the solenoid spring 164 may be sufficient to urge the armature 162 at least partially out of the solenoid assembly 160 when the solenoid assembly 160 is not energized by electrical power. The coil 166 may be configured to energize solenoid assembly 160 and to withdraw the armature 162 into the solenoid assembly 160. The armature 162 may move upwards or downwards along its longitudinal direction as actuated by the coil 166. The armature 162 may be coupled to a poppet 168 which moves together with the armature 162 when the armature 162 moves upwards or downwards along the longitudinal direction of the armature 162.

FIGS. 1B and 1C illustrate components of a two-stage opening structure 170 for the OVR functionality. Referring to FIGS. 1A, 1B and 1C, wherein like numerals indicate like or corresponding parts throughout the several views, the two stage-opening structure 170 of the valve assembly 130 may include, for example, a cage 171, a spring 172, the poppet 168, a main seal 174, an inner seal 143, a hat-shaped valve 142, etc. The spring 172 may be a conical in structure. The cage 171 may be used as a spring guide for the spring 172 in the second stage opening process. The top of the spring 172 may engage an edge surface of the cage 171. The bottom end of the spring 172 may sit on one or more supporting structures provided on the inner sidewall of the housing 132. The spring 172 may against the edge surface of the cage 171, and the supporting structures on the inner sidewall of the housing 132, providing an upward force for the cage 171. The poppet 168 may be contained within the cage 171 and the top end of the poppet 168 may be engaged with the armature 162 through a mechanical coupling mechanism. The poppet 168 may move together with the armature 162 when the later is being actuated by the coil 166.

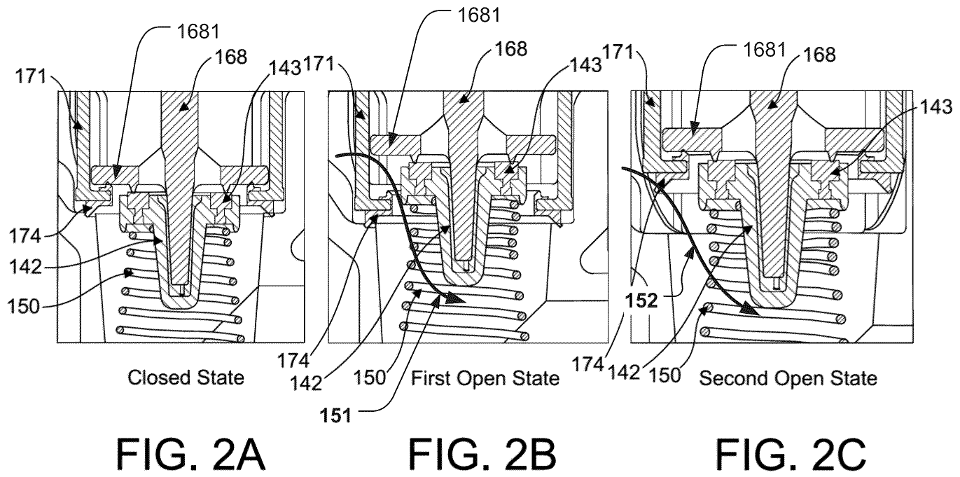

The hat-shaped valve 142 may be mechanically coupled with the inner seal 143 through the protrudes on the inner seal 143 and respective holes on the top edge of the hat-shaped valve 142. The hat-shaped valve 142 and the inner seal 143 above it may be releasably pressed against the downwards facing surface of the seal structure 1681 of the poppet 168. The top end of the spring 150 may push against the edge surface of the hat-shaped valve 142, providing an upward force for the hat-shaped valve, pushing the inner seal 142 on the top of the hat-shaped valve 142 against the downward surface of the seal structure 1861 of the poppet 168. The hat-shaped valve 142 and the inner seal 143 may have a smaller size than the bottom aperture of the cage 171 and may freely pass through the aperture of the cage 171 when pushed by the force from the spring 150 when the poppet 168 moves upwards with the armature 162. The cage seal 174 may be coupled with the bottom end of the cage 174 around the edge of the bottom aperture of the cage 174 (referring to FIGS. 2A, 2B, and 2C). The housing 132 may have a supporting structure on the inner sidewall on which the bottom end of the cage 171 sits. The cage seal 174, which is engaged with the cage bottom aperture edge, may have its bottom seal portion being pushed against the supporting structure for the cage bottom end, sealing the large orifice of the valve as defined by the edge structure of the inner sidewall of the housing 132. The cage seal 174 may have its top seal portion sitting between the bottom edge of the cage and the downward surface of the poppet 168, sealing the small orifice of the valve as defined by the bottom aperture of the cage 171. The cage 171 may have one or more opening on its side wall, providing the flow path for the small orifice.

The poppet 168 may have its bottom end protruding out of the downward surface of the poppet seal structure 1861. The hat-shaped valve 142 may have a hollow structure inside it with the inner shape being customized to receive and fit the protruded end of the poppet 168. The seal structure 168 may be connected to main body of the poppet 168 through one or more connection structures, leaving an inner opening 1683 between the seal structure 1681 and the main body 1682. This flow path may be sealed by the inner seal 143 when the valve assembly is in the closed state.

FIGS. 2A-2C illustrate a two-stage opening process for the OVR functionality. FIG. 2A illustrates a closed state of the valve assembly. FIG. 2A illustrates a first opening stage of the two-stage opening process of the valve assembly. FIG. 2C illustrates a second opening stage of the two-stage opening process of the valve assembly. Referring to FIG. 1 and FIG. 2A, in the closed stage, all paths from the inlet 133 and the outlet 134 may be closed by respective scaling mechanisms. The fuel tank may be a close environment isolated from the engine and may has its inner pressure built up. The fuel tank pressure may be at a high level falling within a pre-determined range (higher than a first threshold value but lower than a second threshold value). The cage 171 may be pressed downwards by the tank pressure with its bottom (which is coupled with the cage seal 171) being pressed against the supporting structure on the inner sidewall of the housing 132. As a result, the cage seal 174 may have its bottom portion being pressed against the cage supporting structure on the inner sidewall of the housing 132, sealing the large orifice of the valve, which is defined by the inner sidewall of the housing 132 and the bottom edge of the cage 171. In the closed state, the poppet 168 may be pressed downwards by the tank pressure. As a result, the cage seal 174 may have its top portion being pressed against the seal structure 1681 of the poppet 158, sealing the small orifice as defined by the bottom aperture of the cage. Furthermore, the hat-shaped valve 142 may be pressed by the spring 150 upwards causing the inner seal 143 being pressed against the downward surface of the seal structure 1681 of the poppet 168, sealing the inner opening 1683 of the poppet 168.

Referring to FIG. 1 and FIG. 2B, in the first open state of the two-stage opening process, the armature 162 may move upwards as pushed by the spring 164 and controlled by the force generated by the coil 166. The poppet 168 may move upwards together with the armature 162. As a result, the downward pressure on the top of the inner seal 143 and the hat-shaped value 142 may be reduced, releasing the downward pressure on the spring 150 under the hat-shaped valve 142. Thus, the spring 150 may push the hat-shaped valve 142 and the inner seal 143 upwards, moving together with the upward moving poppet 168. Because the hat-shaped valve 142 and the inner seal 143 have a smaller size than the bottom aperture of the cage 171, the hat-shaped valve 142 and the inner seal 143 may pass through the bottom aperture of the cage and enter the inner space of the cage 171. As a result, the inner opening of the poppet 168 may remain closed but the small orifice as defined by the bottom aperture of the cage 171 may be opened, forming a path for vapor flow together with the one or more opening on the sidewall of the cage 171 (referring to FIG. 1B). Referring to FIG. 2B, the vapor flow path 151 may be shown by the dark arrow line for explanatory purpose. The pressured fuel vapor from the fuel tank may come in from the inlet 133, pass through the one or more opening on the sidewall of the cage 171, and pass through the small orifice as defined by the bottom aperture of the cage 171 in the open state, reaching the outlet 134 to a canister (not shown) that stores the vapors and is periodically purged.

It is notable that, in particular embodiments, the vapor flow may need to make two or more turns (e.g., 90-degree turns) along this flow path 151 to reach to the outlet 134. After the vapor flow passes through the small orifice in the opening state, the vapor flow may reach outside surface of the hat-shaped valve 142, which may have a sloped or curved surface that is customized to guide the vapor flow to make the turn and reach the outlet 134. In particular embodiments, the hat-shaped valve 142 may have an outside surface that is substantially parallel to an expected flow path 151. In particular embodiments, the hat-shaped valve 142 may have a customized surface that is designed to reduce the friction of the vapor flow and cause fuel vapor to pass the valve assembly with a smoother vapor flow (e.g., a higher speed, reduced friction, avoided turbulence, etc.). The outside surface of the hat-shaped valve 142 may be customized based on one or more parameters including, for examples, the housing dimensions and shapes, the fuel tank pressure ranges, the anticipated vapor flow path, the turning angles in the direction changing of the flow path, the dimensions and shapes of other components along the flow path, etc.

It is notable that, in the first open state, as shown in FIG. 2B, the fuel tank pressure may be higher than a pressure threshold that is high enough to press the cage 171 downwards against the cage supporting structure on the inner sidewall of the housing 132. As a result, the large orifice as defined by the housing 132 may remain in sealed/closed state, limiting the vapor flow path to the smaller orifice as defined by the bottom aperture of the cage 171. As such, the vapor flow in the first open state may be less than the full path flow of the valve assembly 130.

While the fuel vapor in the fuel tank is released through the small orifice in the first open state, the fuel tank pressure may be gradually reduced. When the tank pressure is below the threshold pressure, the pressure may be not sufficient to overcome the force of the spring 172 anymore. As a result, the spring 172 may push the cage 171 upwards, leaving open the large orifice as defined by the inner wall of the housing 132. Referring to FIG. 2C, in the second open state, the cage 171 together with other components contained in the cage 171 (e.g., the poppet 168, the hat-shaped valve 142, the inner scal 143) may move upwards, as pushed by the spring 172 (and partially the spring 150 for the inner components). Referring to FIG. 2C, the vapor flow path 152 may be shown by the dark arrow line for explanatory purpose. The pressured fuel vapor from the fuel tank may come in from the inlet 133 and pass through the large orifice as defined by the bottom aperture of the cage 171 in the open state, reaching the outlet 134 to a canister (not shown) that stores the vapors and is periodically purged. It is notable that in the second open state, the small orifice may be closed again and only the large orifice may be open, which allows the vapor flow to pass at a maximum volume per unit time (i.e., the full vapor releasing capacity of the valve assembly 130). It is notable that the vapor flow may reach the large orifice directly from the inlet 133 without passing through the sidewall opening of the cage 171 like in the first open state.

It is notable that, in particular embodiments, the vapor flow may need to make two or more turns (e.g., 90-degree turns or less degree turns) along this flow path 152 to reach to the outlet 134. After the vapor flow passes through the large orifice in the opening state, the vapor flow may reach outside surface of the hat-shaped valve 142, which may have a sloped or curved surface that is customized to guide the vapor flow to make the turn and reach the outlet 134. In particular embodiments, the hat-shaped valve 142 may have an outside surface that is substantially parallel to an expected flow path 152. In particular embodiments, the hat-shaped valve 142 may have a customized surface that is designed to reduce the friction of the vapor flow and cause fuel vapor to pass the valve assembly with a smoother vapor flow (e.g., a higher speed, reduced friction, avoided turbulence, etc.). The outside surface of the hat-shaped valve 142 may be customized based on one or more parameters including, for examples, the housing dimensions and shapes, the fuel tank pressure ranges, the anticipated vapor flow path, the turning angles in the direction changing of the flow path, the dimensions and shapes of other components along the flow path, etc.

In particular embodiments, the housing 132 may accommodate an OPR valve (140 in FIG. 1) in an in-line relationship relative to the poppet 168. The OPR valve 140 may include a piston or a hat-shaped valve 142 that is configured to selectively seal against the seal structure 1681 of the poppet 168. The hat-shaped valve 142 may be normally urged against the inner seal 143 to close a passage formed by the inner opening 1683 of the poppet by the OPR spring 150. When there is excessive pressure above a threshold value, the tank pressure may be sufficient to overcome the spiring force of the spring 150. The hat-shaped (cone-shaped) valve may be pushed downwards by the tank pressure to mechanically open the inner opening 1683 of the poppet 168 temporarily to release pressure. Once the tank pressure is reduced to be below the threshold value, the spring 150 may push the hat-shaped valve 142 upwards to re-seal the flow passage. As a result, the OPR functionality may be achieved by pushing the hat-shaped valve downwards.

It is notable that the two-stage opening of OVR functionality may complete depressurize the fuel tank to atmosphere pressure level in response to, for example, a user's pushing of a depressurization button before a refuel event. The OPR functionality may respond to a higher tank pressure only above a threshold value and mechanically release the fuel tank pressure to be lower than the threshold value. The OPR may only open the valve temporarily and may close the valve mechanically as driven by the spring force of the spring 150 under the hat-shaped valve 142.

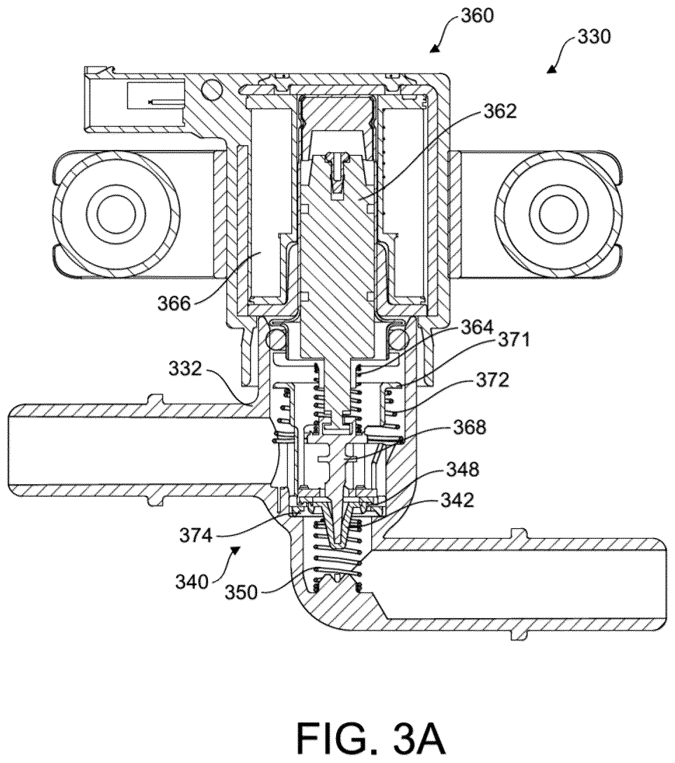

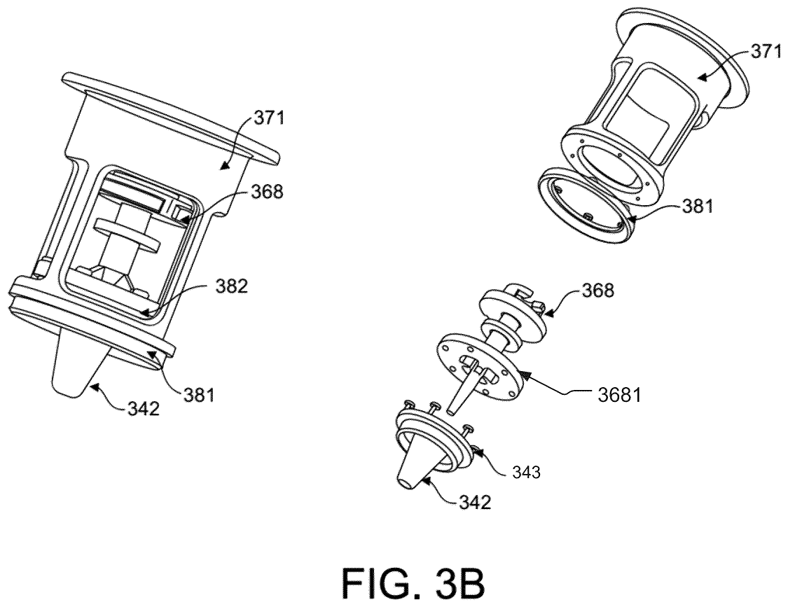

FIG. 3A illustrates a valve system 330 used in a 180-degree valve assembly housing 332 according to another embodiment of this disclosure. FIG. 3B illustrates the assembled view and the explored view for some of the assembly components including the poppet 368. The valve system 330 may have a poppet 368 which has a different structure with the poppet 168 in the valve system 130. Referring to FIG. 3B, the cage seal 381 may be coupled with the bottom of the cage 371 through the protrudes on the top of the cage seal 381 and the respective holes on the bottom edge of the cage 371. The inner seal 343 may be coupled to the seal structure 3681 through the protrudes on the top surface of the inner seal 343 and respective holes on the seal structure 3681 of the poppet 368. The hat-shaped valve 342 may be pressed against the bottom surface of the inner seal 343 as pressed by the spring 350 under it. Besides these difference in the implementation, the valve system 330 may operate similar with the valve system 130 for the two-stage opening process for OVR functionality and for the ORP functionality.

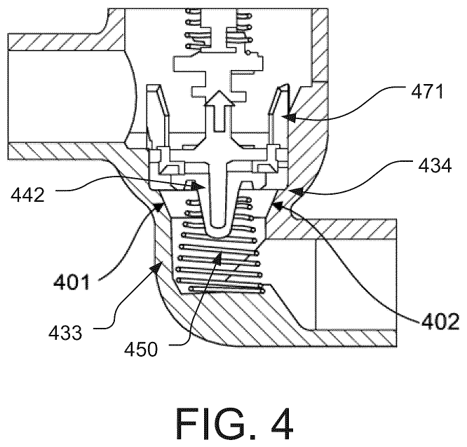

FIG. 4 illustrates a chamfer step (401, 402) on the inner sidewall of the housing. In particular embodiments, the valve assembly may have a chamfer step (e.g., 401, 402) on the inner sidewall of the housing 433. The chamfer step (e.g., 401, 402) may help to increase the flow passage for pressure drop improvement and facilitate assembling the OPR spring 450 on to the spring seat at the bottom of the housing 432. The chamfer step (e.g., 401, 402) may be under the supporting structure 434 for the bottom edge of the cage 471 (partially shown). The slope or angle of the chamfer step (e.g., 401, 402) may be customized based on the shape of the outside surface of the hat-shaped valve 442, the anticipated flow path, the fuel tank pressure range, the dimensions and shapes of other nearly components, etc. The chamfer step (e.g., 401, 402) may further reduce the friction for the vapor flow passing through the valve and avoid the turbulence. In particular embodiments, the chamfer step (e.g., 401, 402) may be substantially parallel to the outside surface of the hat-shaped valve 442.

The following embodiments can be claimed as well in any combination thereof as indicated by reference back and also in combination with other features described in this disclosure, in particular by replacing the term “embodiment” by the term “claim” to arrive at a corresponding claim set.

Embodiment 1: A valve assembly for a fuel tank, comprising: a housing; a cage arranged inside the housing, wherein the cage has a first orifice as defined by a bottom edge sitting on a first supporting structure located at a first position of an inner sidewall of the housing; a first spring arranged inside the housing and outside of the cage, wherein the first spring has a top end pressing against a top edge of the cage and a bottom end sitting on a second supporting structure located at a second position of the inner sidewall of the housing; and a poppet arranged inside the cage, wherein the poppet has a top end coupled to an armature movable longitudinally, and a bottom end coupled to a hat-shaped valve, wherein: the hat-shaped valve is arranged inside the housing and coupled to a second spring under the hat-shaped valve; and the second spring is configured to push the hat-shaped valve upwards and cause the hat-shaped valve to be releasably engaged with a seal structure of the poppet.

Embodiment 2: A valve assembly for a fuel tank, comprising: a housing; a cage arranged inside the housing, wherein the cage has a first orifice as defined by a bottom edge sitting on a first supporting structure located at a first position of an inner sidewall of the housing; a first spring arranged inside the housing and outside of the cage, wherein the first spring has a top end pressing against a top edge of the cage and a bottom end sitting on a second supporting structure located at a second position of the inner sidewall of the housing; and a poppet arranged inside the cage, wherein the poppet has a top end coupled to an armature movable longitudinally, and a bottom end coupled to a hat-shaped valve, wherein the hat-shaped valve has an outside surface customized to guide vapor flow when the vapor flow passes through the valve assembly.

Embodiment 3: The valve assembly of Embodiment 1 or Embodiment 2, wherein the housing is connected to an inlet and an outlet, and wherein the inlet is connected to the fuel tank and the outlet is connected to a canister configured to store fuel vapor released from the fuel tank through the inlet and the valve assembly.

Embodiment 4: The valve assembly of any of the Embodiments 1-3, wherein the hat-shaped valve has a sloped or curved outside surface configured to guide a vapor flow to reduce friction when the vapor flow is released from the fuel tank, passing through the inlet and the valve assembly to reach to the outlet.

Embodiment 5: The valve assembly of Claim any of the preceding Embodiments, wherein the first orifice corresponds to a bottom aperture as defined by the bottom edge of the cage, and wherein, in a closed state, the first orifice is sealed by the seal structure of the poppet through a top portion of a cage seal coupled to the bottom edge of the cage.

Embodiment 6: The valve assembly of any of the preceding Embodiments, wherein the inner sidewall of the housing at the first position defines a second orifice, and wherein the second orifice is sealed by the bottom edge of the cage in a closed state through a cage seal.

Embodiment 7: The valve assembly of any of the preceding Embodiments, wherein the cage has one or more openings on a cage sidewall configured to allow vapor flow to pass through.

Embodiment 8: The valve assembly of any of the preceding Embodiments, wherein the poppet has an inner opening in the seal structure of the poppet, and wherein the inner opening of the poppet is sealed by an inner seal on the top of the hat-shaped valve as pressed by the second spring under the hat-shaped valve.

Embodiment 9: The valve assembly of any of the preceding Embodiments, wherein, when the valve assembly switches from the closed state to a first open state of a two-stage opening process, the poppet is configured to move upwards with the armature, and wherein the first orifice corresponding to the bottom aperture of the cage is opened in the first open state.

Embodiment 10: The valve assembly of Embodiment 9, wherein, in the first open state of the two-stage opening process, the fuel tank has an inner pressure being higher than a threshold pressure, and wherein the second orifice remains being sealed by the bottom edge of the cage as pressed downwards by the inner pressure of the fuel tank.

Embodiment 11: The valve assembly of any of the Embodiments 1-8, wherein, when the valve assembly switches from a first open stage to a second open state of the two-stage opening process, the inner pressure of the fuel tank is lower than the threshold pressure, wherein the first spring is configured to push the cage upwards overcoming the inner pressure of the fuel tank, and wherein the second orifice is opened in the second open state.

Embodiment 12: The valve assembly of Embodiment 11, wherein, in the second open state, the cage, the poppet, and the hat-shaped valve are at higher positions, and wherein the first orifice is closed.

Embodiment 13: The valve assembly of any of the Embodiments 1-8, wherein, when the fuel tank has an inner pressure higher than a high-threshold pressure that is greater than a spring force of the second spring, the hat-shaped valve is configured to move downwards to temporarily open an inner opening of the seal structure of the poppet to release the inner pressure of the fuel tank.

Embodiment 14: The valve assembly of Embodiment 13, wherein, when the inner pressure of the fuel tank falls under the high-threshold pressure, the hat-shaped valve is configured to move upwards to reseal the inner opening of the seal structure of the poppet.

Embodiment 15: The valve assembly of any of the preceding Embodiments, wherein the hat-shaped valve is hollow inside and has an inner surface shape customized to receive a protrude of the poppet extending beyond a bottom surface of the seal structure of the poppet, and wherein the hat-shaped valve has a smaller size than the first orifice corresponding to the bottom aperture of the cage.

Embodiment 16: The valve assembly of any of the preceding Embodiments, wherein the hat-shaped valve is mechanically coupled to an inner seal which is releasably pressed against a bottom surface of the seal structure of the poppet, and wherein the bottom edge of the cage is mechanically coupled to a cage seal.

Embodiment 17: The valve assembly of any of Embodiments 1-15, wherein the seal structure of the poppet is mechanically coupled to an inner seal which is releasably pressed against a top surface of the hat-shaped valve, and wherein the bottom edge of the cage is mechanically coupled to a cage seal.

Embodiment 18: The valve assembly of any of the preceding Embodiments, wherein the inner sidewall of the housing has a chamfer step under the first supporting structure for the cage, and wherein the chamfer step is configured to smooth vapor flow passing through the valve assembly.

Embodiment 19: The valve assembly of any of the preceding Embodiments, wherein the valve assembly is configured to release an inner pressure of the fuel tank using a two-stage opening process to limit a peak flow of fuel vapor.

Embodiment 20: The valve assembly of any of the preceding Embodiments, wherein the valve assembly is configured to release an inner pressure of the fuel tank using a mechanical valve when the inner pressure is higher than a threshold pressure.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C. Numerical ranges recited in this application should be construed to be inclusive of the end points of the stated ranges. The longitudinal axis of the valve body, which may have been omitted in some illustrations for convenience of scale, should be construed to exist in every illustration where it is referred to.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A valve assembly for a fuel tank, comprising:
a housing;
a cage arranged inside the housing, wherein the cage has a first orifice as defined by a bottom edge sitting on a first supporting structure located at a first position of an inner sidewall of the housing;
a first spring arranged inside the housing and outside of the cage, wherein the first spring has a top end pressing against a top edge of the cage and a bottom end sitting on a second supporting structure located at a second position of the inner sidewall of the housing; and
a poppet arranged inside the cage, wherein the poppet has a top end coupled to an armature movable longitudinally, and a bottom end coupled to a hat-shaped valve, wherein:
the hat-shaped valve is arranged inside the housing and coupled to a second spring under the hat-shaped valve; and
the second spring is configured to push the hat-shaped valve upwards and cause the hat-shaped valve to be releasably engaged with a seal structure of the poppet.

2. The valve assembly of claim 1, wherein the housing is connected to an inlet and an outlet, and wherein the inlet is connected to the fuel tank and the outlet is connected to a canister configured to store fuel vapor released from the fuel tank through the inlet and the valve assembly.

3. The valve assembly of claim 2, wherein the hat-shaped valve has a sloped or curved outside surface configured to guide a vapor flow to reduce friction when the vapor flow is released from the fuel tank, passing through the inlet and the valve assembly to reach the outlet.

4. The valve assembly of claim 1, wherein the first orifice corresponds to a bottom aperture as defined by the bottom edge of the cage, and wherein, in a closed state, the first orifice is sealed by the seal structure of the poppet through a top portion of a cage seal coupled to the bottom edge of the cage.

5. The valve assembly of claim 4, wherein the inner sidewall of the housing at the first position defines a second orifice, and wherein the second orifice is sealed by the bottom edge of the cage in a closed state through a cage seal.

6. The valve assembly of claim 1, wherein the cage has one or more openings on a cage sidewall configured to allow vapor flow to pass through.

7. The valve assembly of claim 1, wherein the poppet has an inner opening in the seal structure of the poppet, and wherein the inner opening of the poppet is sealed by an inner seal on the top end of the hat-shaped valve as pressed by the second spring under the hat-shaped valve.

8. The valve assembly of claim 5, wherein, when the valve assembly switches from the closed state to a first open state of a two-stage opening process, the poppet is configured to move upwards with the armature, and wherein the first orifice corresponding to the bottom aperture of the cage is opened in the first open state.

9. The valve assembly of claim 8, wherein, in the first open state of the two-stage opening process, the fuel tank has an inner pressure being higher than a threshold pressure, and wherein the second orifice remains sealed by the bottom edge of the cage as pressed downwards by the inner pressure of the fuel tank.

10. The valve assembly of claim 9, wherein, when the valve assembly switches from the first open state to a second open state of the two-stage opening process, the inner pressure of the fuel tank is lower than the threshold pressure, wherein the first spring is configured to push the cage upwards overcoming the inner pressure of the fuel tank, and wherein the second orifice is opened in the second open state.

11. The valve assembly of claim 10, wherein, in the second open state, the cage, the poppet, and the hat-shaped valve are at higher positions, and wherein the first orifice is closed.

12. The valve assembly of claim 1, wherein, when the fuel tank has an inner pressure higher than a high-threshold pressure that is greater than a spring force of the second spring, the hat-shaped valve is configured to move downwards to temporarily open an inner opening of the seal structure of the poppet to release the inner pressure of the fuel tank.

13. The valve assembly of claim 12, wherein, when the inner pressure of the fuel tank falls under the high-threshold pressure, the hat-shaped valve is configured to move upwards to reseal the inner opening of the seal structure of the poppet.

14. The valve assembly of claim 1, wherein the hat-shaped valve is hollow inside and has an inner surface shape customized to receive a protrude of the poppet extending beyond a bottom surface of the seal structure of the poppet, and wherein the hat-shaped valve has a smaller size than the first orifice.

15. The valve assembly of claim 1, wherein the hat-shaped valve is mechanically coupled to an inner seal which is releasably pressed against a bottom surface of the seal structure of the poppet, and wherein the bottom edge of the cage is mechanically coupled to a cage seal.

16. The valve assembly of claim 1, wherein the seal structure of the poppet is mechanically coupled to an inner seal which is releasably pressed against a top surface of the hat-shaped valve, and wherein the bottom edge of the cage is mechanically coupled to a cage seal.

17. The valve assembly of claim 1, wherein the inner sidewall of the housing has a chamfer step under the first supporting structure for the cage, and wherein the chamfer step is configured to smooth vapor flow passing through the valve assembly.

18. The valve assembly of claim 1, wherein the valve assembly is configured to release an inner pressure of the fuel tank using a two-stage opening process to limit a peak flow of fuel vapor.

19. The valve assembly of claim 1, wherein the valve assembly is configured to release an inner pressure of the fuel tank using a mechanical valve when the inner pressure is higher than a threshold pressure.

20. A valve assembly for a fuel tank, comprising:
a housing;
a cage arranged inside the housing, wherein the cage has a first orifice as defined by a bottom edge sitting on a first supporting structure located at a first position of an inner sidewall of the housing;
a first spring arranged inside the housing and outside of the cage, wherein the first spring has a top end pressing against a top edge of the cage and a bottom end sitting on a second supporting structure located at a second position of the inner sidewall of the housing; and
a poppet arranged inside the cage, wherein the poppet has a top end coupled to an armature movable longitudinally, and a bottom end coupled to a hat-shaped valve, wherein the hat-shaped valve has an outside surface customized to guide vapor flow when the vapor flow passes through the valve assembly.
